(19) United States
(12) Patent Application Publication
(10) Pub. No.: US 2015/0092013 A1
(43) Pub. Date: Apr. 2, 2015

(54) METHOD AND A DEVICE FOR TRANSMITTING AT LEAST A PORTION OF A SIGNAL DURING A VIDEO CONFERENCE SESSION

(71) Applicant: Orange, Paris (FR)

(72) Inventors: Yoann Noisette, May Sur Orne (FR); Pierre Levis, Caen (FR)

(21) Appl. No.: 14/502,941

(22) Filed: Sep. 30, 2014

(30) Foreign Application Priority Data
Sep. 30, 2013 (FR) 1359457

(51) Int. Cl. H04N 7/15

(52) U.S. Cl. CPC H04N 7/152
USPC 348/14.09

(57) ABSTRACT

A method and a device for transmitting at least a portion of a signal during a video conference session is disclosed. In one aspect, a method of transmitting at least a portion of a signal acquired by a first terminal to one second terminal during a video conference session, the signal comprising an audio stream and a video stream conveying images acquired with the help of one video image sensor is disclosed. The method comprises obtaining a parameter representative of a quality of the acquisition performed by the sensor of the video images conveyed by the video stream of the signal, and a process of notifying the first terminal of information representative of the acquisition quality. If this parameter is representative of an acquisition quality that is higher than a predetermined level, both the audio stream and the video stream of the signal are transmitted to the second terminal. Otherwise, the audio stream is transmitted to the second terminal and the video stream is blocked so that it is not transmitted to the second terminal.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57 in their entireties. In particular, the disclosure of French Application 1359457, filed Sep. 30, 2013, is incorporated herein by reference in its entirety.

### BACKGROUND OF THE INVENTION

The invention relates to the general field of telecommunications. It relates more particularly to video conference services.

In known manner, a video conference service is a service providing real time transmission of speech signals (i.e. audio streams) and video images (i.e. video streams) between parties who may be in two different locations (point-to-point communication) or in more than two different locations (multipoint communication).

Video conference services present numerous advantages for businesses and for individuals. They provide an advantageous alternative to having face-to-face meetings, in particular in terms of cost and time, and they make it possible to limit physical travel for the participants.

These services are also attractive since they are easily accessible and can be adapted to various contexts.

In a professional context, video conference services conventionally rely on the use of dedicated video conference rooms that are specifically equipped for this purpose (e.g. good lighting and framing conditions, the use of high quality equipment for image acquisition and playback, properly adjusted equipment, etc.), in order to control and optimize the quality of the service given and the experience of the users.

Such dedicated and optimized installations also include the possibility of connecting with video conference services from terminals other than those initially designed for that purpose, such as personal computers, tablets, or smartphones, providing such a terminal is fitted with a camera and a microphone.

Other video conference services make no use of a dedicated installation, but make use solely of terminals, e.g. such as mobile terminals, that were not originally designed for that purpose and that are connected together.

Such terminals nevertheless do not provide the same comfort or the same image quality as dedicated equipment. In addition to having technical capabilities that are often not as good as those of dedicated equipment, the conditions under which such terminals are used in the context of video conference services can also have a negative impact on the quality of the video image that is acquired and transmitted to the participants (the existence of backlighting, the user of the terminal moving, the user being poorly positioned relative to the camera, etc.). This means that the participants have a poor experience of the video conference service and the service suffers from poor management of its resources.

It should be observed that video conference rooms and terminals dedicated to this function can themselves also be improperly adjusted, likewise generating images of degraded quality in the same manner as equipment that is not dedicated to the video conference function.

In order to mitigate those drawbacks, one solution consists in performing various adjustments to the video while installing the terminals. Nevertheless, those adjustments do not necessarily remain valid throughout subsequent uses, and they are rarely changed in practice.

Another solution consists in making use of cameras and/or light sources that are controlled by the video conference service and that are servo-controlled on the visual quality of the video streams that are recorded and transmitted to the participants.

Thus, by way of example, the article by Mingxuan Sun et al., entitled “Active lighting for video conferencing”, IEEE Transactions on Circuits and Systems for Video Technology, Vol. 19, No. 12, December 2009, proposes a system that makes it possible to act in real time on a light-emitting diode (LED) lighting system. Nevertheless, such a solution is relatively complex, in particular because of the processing that is performed. Furthermore, it only addresses problems associated with lighting conditions. Thus in spite of the processing applied by the system, it can happen that the image shown to participants in the video conference is still of poor quality.

In similar manner, Document US 2012/0274724 proposes a solution that relies on real time analysis of visual quality in the video streams that are recorded, which streams are then automatically reprocessed so as to improve their contrast prior to being transmitted to the other participants. Like the preceding solution, that solution nevertheless remains limited, in particular concerning the problems that it addresses and the complexity of performing it.

There therefore exists a need for a simple and effective solution that makes it possible to improve the experience of the users of a video conference service.

### OBJECT AND SUMMARY OF THE INVENTION

Some embodiments of the present invention satisfy this need in particular by proposing a method of transmitting at least a portion of a signal acquired by a first terminal to at least one second terminal during a video conference session, the signal comprising an audio stream and a video stream conveying video images acquired with the help of at least one video image sensor associated with the first terminal, said transmission method comprising:

a parameter-obtaining process for obtaining a parameter representative of a quality of the acquisition performed by the sensor of the video images conveyed by the video stream of the signal;

a notifying process for notifying the first terminal of at least one item of information representative of the acquisition quality of the video images conveyed by the video stream, said representative information enabling a user of said first terminal to take corrective action seeking to improve the acquisition quality of the video images by said sensor; and

if this parameter is representative of an acquisition quality that is higher than a predetermined quality level, a process of transmitting both the audio stream and the video stream of the signal to said at least one second terminal;

or else:

a process of transmitting the audio stream to said at least one second terminal; and

a process of blocking the video stream so that the video stream is not transmitted to said at least one second terminal.

One embodiment of the invention thus proposes transmitting or blocking a video stream constituted by a sequence of images acquired by a video image sensor during a video conference session as a function of the quality of the acquisition of these images by the sensor, while the corresponding audio stream is always transmitted. The fact of a participant's image not being transmitted does not mean that the participant is excluded from the video conference: in accordance with this embodiment of the invention, since the audio stream continues to be available for the other participants, that person continues to be one of them.

As used herein, the term “acquisition quality” relating to the quality of the acquisition performed by the sensor of images conveyed by a video stream is used without distinction to designate the quality of the physical characteristics of the video stream (signal), such as image resolution (e.g. high definition or otherwise), and/or the quality of the conditions under which the images conveyed by the video stream were acquired by the video image sensor, in other words the “cinematographic” quality or indeed the “photographic” quality of the images in the video stream. In the professional fields of cinema and video, such cinematographic quality is the responsibility of the director of photography (or chief operator). It relates in particular on certain major characteristics of a video image, such as for example color, framing, lighting, and digital stability of the sensor, which characteristics reflect the conditions under which the image is acquired by the video image sensor in question (e.g. webcam, high definition camera, etc.).

The inventors have advantageously correlated these characteristics with the perception of participants in a video conference. Thus, in a particular implementation of the invention, the parameter representative of a quality of the acquisition performed by the sensor of the images conveyed by the video stream takes account of at least one quality selected from:

a quality relating to framing of the video images conveyed by the video stream and acquired by the video image sensor (this quality seeks in particular to detect the presence of one or more heads being shown in part only in the images, or of heads that do not occupy enough space in the image, etc.);

a quality relating to the stability of the video image sensor while acquiring the video images conveyed by the video stream (the idea being in particular to detect excessive movement of the sensor while acquiring images); and

a quality relating to lighting during acquisition of the video images conveyed by the video stream (in particular for the purpose of detecting the presence of backlighting, of light that is too bright, etc.).

Naturally, other criteria may be taken into account in order to determine whether the acquisition quality of the images in the video stream is or is not sufficient, whether this be for technical reasons or, in a variant, for reasons of appearance (color harmonies, clothing of participants, quality of the background of the user of the first terminal in terms of color and bulk, for example, etc.).

By way of example, this item of information representative of the acquisition quality of the video images conveyed by the video stream as notified to the first terminal may be in the form of quality indices calculated from the images of the video stream (e.g. a framing, stability, or lighting video index), or messages that are more specific such as “framing quality insufficient”, or indeed instructions to the user of the first terminal for improving this quality.

Thus, and in particularly advantageous manner, the user of the first terminal can use this information to take corrective action seeking to improve the acquisition quality of the video stream and consequently to improve the quality of the playback of the image being broadcast during the video conference service.

In a particular implementation of the invention, the notifying process is performed only when said parameter is representative of an acquisition quality that is not greater than said predetermined quality level.

In accordance with one embodiment of the invention, the acquisition quality of the images in the video stream is advantageously analyzed in real time relative to the acquisition of the images of the video stream.

Thus, for example, the process of obtaining the parameter (and correspondingly the transmitting and/or blocking processes that result therefrom) may be performed periodically.

In a variant, the process of obtaining the parameter maybe performed when starting the video conference session between the first terminal and said at least one second terminal.

Whatever the moment at which acquisition quality is analyzed and/or the rate at which acquisition quality analysis is repeated, some embodiments of the invention make it possible to respond quickly (i.e. in real time) by avoiding broadcasting to the participants of the video conference service any images of acquisition quality that is judged to be insufficient and that could degrade the experience of the participants and their perception of the video conference service. Poor “cinematographic” quality or in equivalent manner poor acquisition of the video signal leaves the final user who receives the images of the other party with a poor experience of the video conference service. This poor “cinematographic” quality also impedes good quality communication between two participants.

Furthermore, the solution proposed by some embodiments of the invention makes it possible simultaneously to avoid wasting the resources needed for conveying and processing such images when they are of insufficient quality.

This solution is also particularly simple and effective. It serves to improve the experience of participants to the video conference service without requiring expensive reprocessing of the acquired video images, thereby making it easier to implement, in particular on lightweight terminals, such as mobile terminals, for example.

Furthermore, by deciding merely to cut off transmission of the video stream when the acquisition quality of the image in that stream is insufficient, some embodiments of the invention make it possible to accommodate various different causes that may be behind the insufficient quality. The solution proposed by some embodiments of the invention does not seek to deal with any particular cause but to improve the overall experience perceived by the participants to the video conference.

In a particular implementation, the transmission method further includes a process of transmitting a predetermined image to said at least second terminals if the parameter is not representative of acquisition quality greater than a predetermined quality level.

This predetermined image (i.e. a still) may for example be a black image, an image of uniform color, or indeed an image selected in advance by the user of the first terminal or of the second terminal (e.g. an image of the user of the first terminal). Transmitting this image consumes a small amount of bandwidth while improving the experience of the participants to the video conference.

In a particular implementation, following a process of blocking the video stream, the transmission method includes a process of activating transmission of the video stream together with the audio stream if the acquisition quality is greater than the predetermined quality level for at least a predefined duration.

In other words, blocking of the video stream is not necessarily final. The video stream may be transmitted once again as soon as it is detected that it presents acquisition quality that is sufficient in the light of the predetermined criteria. Appropriately choosing the duration serves to avoid problems of instability (a hysteresis mechanism).

In a variant, it is possible on the contrary to envisage that blocking of the video stream is final throughout the duration of the video conference session, in particular when the process of obtaining the parameter is performed at the beginning of the video conference session and at that time only.

The parameter representative of the acquisition quality of the video images conveyed by the video stream of the signal acquired by the first terminal may be obtained in various ways.

Thus, in a particular implementation, this parameter is obtained from at least one quality index calculated by the sensor and transmitted together with the signal and/or on the basis of information contained in the video stream.

By way of example, such a quality index may be:

an index relating to framing quality, seeking to detect whether an expected pertinent portion (e.g. the face of the user of the first terminal) of the video image is properly framed relative to the expectations of the participants;

an index relating to the stability quality of the sensor while acquiring video images; and

an index relating to the quality of lighting, seeking in particular to detect insufficient light or contrast, and also to detect the presence of backlighting.

It should be observed that other indices may also be taken into account, such as an index relating to the quality of the color composition of the filmed scene.

In a particular implementation, the various processes of the transmission method are determined by computer program instructions.

Consequently, some embodiments of the invention also provide a computer program on a data medium, the program being suitable for being performed in a transmission device, in a terminal, in a video conference server, or more generally in a computer, the program including instructions adapted to performing processes of a transmission method as described above.

The program may use any programming language, and be in the form of source code, object code, or code intermediate between source code and object code, such as in a partially compiled form, or in any other desirable form.

Some embodiments of the invention also provide a computer readable data medium, including instructions of a computer program as mentioned above.

The data medium may be any entity or device capable of storing the program. For example, the medium may comprise storage means, such as a read only memory (ROM), e.g. a compact disk (CD) ROM, or a microelectronic circuit ROM, or indeed magnetic recording means, e.g. a floppy disk or a hard disk.

The data medium may also be a transmissible medium such as an electrical or optical signal, which may be conveyed via an electrical or optical cable, by radio, or by other means. The program of some embodiments of the invention may in particular be downloaded from an Internet type network.

Alternatively, the data medium may be an integrated circuit in which the program is incorporated, the circuit being adapted to execute or to be used in the execution of the method in question.

Some embodiments of the invention also provide a transmission device for transmitting at least a portion of a signal acquired by a first terminal to at least one second terminal during a video conference session, the signal comprising an audio stream and a video stream conveying video images acquired with the help of at least one video image sensor associated with the first terminal, the transmission device comprising:

a module for obtaining a parameter representative of a quality of the acquisition performed by the sensor of the video images conveyed by the video stream of the signal;

a module for notifying the first terminal of at least one item of information representative of the acquisition quality of the video images conveyed by the video stream, said representative information enabling a user of said first terminal to take corrective action seeking to improve the acquisition quality of the video images by said sensor;

a module for transmitting both the audio stream and the video stream of the signal to said at least one second terminal, which module is activated if the parameter is representative of an acquisition quality greater than a predetermined quality level; and

said device being suitable for activating, when said parameter (PQA) is representative of an acquisition quality that is not greater than said predetermined quality level:

a module for transmitting the audio stream to said at least one second terminal; and

a module for blocking the video stream so that the video stream is not transmitted to said at least one second terminal.

The transmission device may be located in the network, at a central video conference server acting as intermediary between the terminals participating in the video conference service. Such a server is generally used with multipoint communications in order to route the video streams and/or in order to generate a video mosaic presenting some or all of the video streams acquired by each of the users of the video conference system.

Some embodiments of the invention also provide a video conference server including a transmission device of the invention.

This embodiment serves to save server resources since it is not required to process (e.g. decode, etc.) the images received from the first terminal when they are of acquisition quality that is insufficient, and serves to save resources of the network connecting the server to the terminals participating in the video conference.

In a variant, the transmission device may be incorporated locally in the first terminal. Thus, some embodiments of the invention also provide a terminal including a transmission device as described herein.

This embodiment is particularly advantageous in that it further serves to save resources since the video stream is blocked at the first terminal and is never sent over the network to the second terminal or to the video conference server, as the case may be.

In another aspect, some embodiments of the invention also provide a video conference system comprising:

a first terminal and at least one second terminal; and

a transmission device as described herein, suitable for transmitting at least a portion of a signal acquired by the first terminal to said at least one second terminal during a video conference session, the signal comprising an audio stream and a video stream conveying video images acquired with the help of at least one video image sensor associated with the first terminal.

The system benefits from the same above-mentioned advantages as the transmission method and the transmission device.

In other embodiments and implementations, it is also possible to envisage that the transmission method, the transmission device, and the system described herein present in combination all or some of the above-mentioned characteristics.

### BRIEF DESCRIPTION OF THE DRAWINGS

Other particular characteristics and advantages of some embodiments of the present invention appear from the detailed description made with reference to the figures, in which:

FIG. 1 shows a video conference system in accordance with a first embodiment of the invention;

FIG. 2 shows an example of hardware architecture for a transmission device of one embodiment of the invention;

FIG. 3 is in the form of a flow chart showing the main process of a transmission method in accordance with one embodiment of the invention in a variant implementation;

FIG. 4 is in the form of an exemplary flow chart showing a hysteresis mechanism used during the transmission method to govern the activation of transmission of the video stream after it has been blocked;

FIG. 5 shows an example of obtaining quality indices making it possible to determine a quality parameter as used during the processes of the transmission method shown in FIG. 3; and

FIG. 6 shows a video conference system and a video conference server incorporating a transmission device, both in accordance with a second embodiment of the invention.

### DETAILED DESCRIPTION OF THE INVENTION

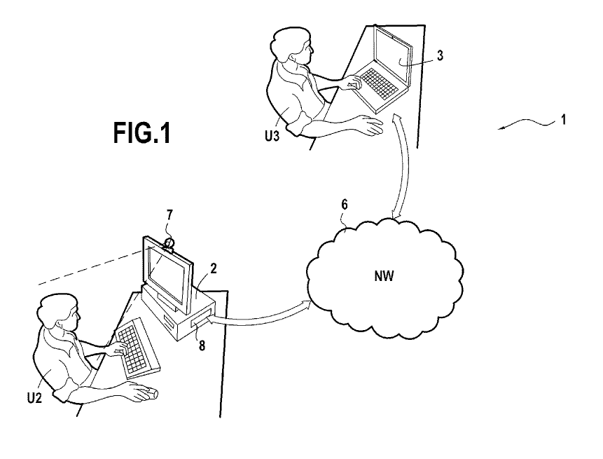

FIG. 1 shows a video conference system 1 in accordance with a first embodiment of the invention.

The video conference system 1 comprises:

a plurality of terminals 2 and 3 participating in a video conference and communicating with one another via a telecommunications network 6; and

a transmission device 8 in accordance with the invention.

The terminal 2 is a terminal in accordance with one embodiment of the invention (a “first” terminal in the meaning of one embodiment of the invention). In the example shown in FIG. 1, it comprises a computer having a video image sensor 7 (specifically a webcam) enabling its user U2 to participate in a video conference with the user U3 of the terminal 3. By way of example, the terminal 3 shown is a laptop computer.

More precisely, the sensor 7 associated with the terminal 2 enables it to acquire a video of the user U2 for transmission to the other participants in the video conference (i.e. to the terminal 3 in this example). The video constitutes a signal in the meaning of one embodiment of the invention comprising both an audio stream and a video stream.

No limitation is associated with the number or the nature of the terminals participating in the video conference, nor with the nature of the telecommunications network 6 interconnecting the terminals. Thus, the terminals 2 and 3 may equally well be desktop or laptop computers, smartphones, digital tablets, or indeed dedicated video conference equipment, etc., so long as the terminals are provided with video conference application software (program) and are connected together, typically via a telecommunications network. Likewise, the telecommunications network 6 may be a mobile network (e.g. the universal mobile telecommunications system (UMTS)) or a wired fixed network (e.g. Ethernet), or a wireless fixed network (e.g. a wireless local area network (WLAN)), that may be private or public, etc.

In accordance with one embodiment of the invention, prior to being transmitted to the terminal 3 (the “second” terminal in the meaning of one embodiment of the invention), the video signal acquired by the sensor 7 is processed by the transmission device 8 so as to block transmission of the video stream of the signal (i.e. block only the images in the signal) whenever the quality with which video images are acquired by the webcam 7 is insufficient.

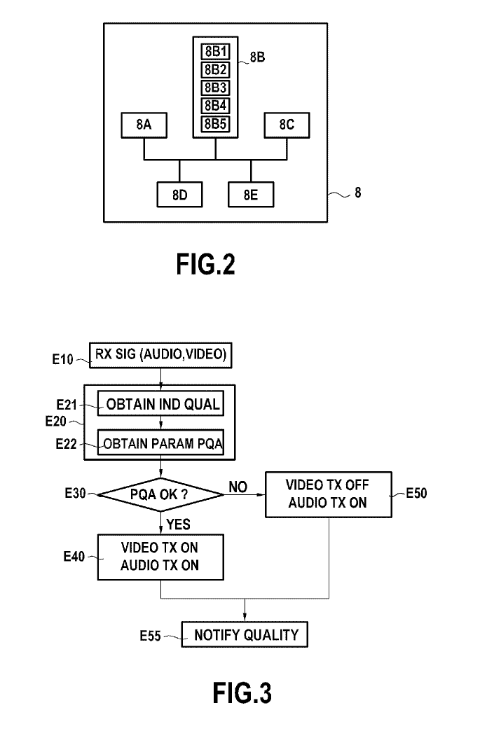

In the first embodiment described herein, the transmission device 8 is incorporated in the terminal 2. It has the hardware architecture of a computer, as shown diagrammatically in FIG. 2.

Thus, the transmission device 8 comprises in particular a processor 8A, a ROM 8B, a random access memory (RAM) 8C, a non-volatile memory 8D, and communications means 8E for communicating over the telecommunications network 6. The processor 8A, the memories 8B-8D, and the communications means 8E may optionally be shared with corresponding means of the terminal 2.

The ROM 8B of the transmission device constitutes a recording medium readable by the processor 8A and having recorded thereon a computer program in accordance with one embodiment of the invention, the program including instructions for executing a transmission method in accordance with one embodiment of the invention, the transmission method being described below with reference to FIG. 3 in a particular implementation.

In equivalent manner, this computer program defines functional modules of the transmission device 8, such as in particular a receive module 8B1 for receiving a signal comprising an audio stream and a video stream as acquired by the terminal 2, a parameter-obtaining module 8B2 for obtaining a parameter representative of the acquisition quality of video stream, a notification module 8B5 for notifying the terminal 2 of at least one item of information representative of the acquisition quality of the video images conveyed by the video stream, a transmit module 8B3 for transmitting at least a portion of the signal to the terminal 3, and a blocker module 8B4 for blocking the video stream of the signal if the acquisition quality of this stream is insufficient. The receive module 8B 1 and the transmit module 8B3 make use in particular of the communications means 8E. Their functions are described in greater detail with reference to the processes of the transmission method shown in FIG. 3.

There follows a description with reference to FIG. 3 of the main processes of an exemplary transmission method of one embodiment of the invention in an implementation where it is performed during a video conference session between the terminal 2 and the terminal 3 by the transmission device 8 incorporated in the terminal 2.

It is assumed that during a video conference session set up between the terminal 2 and the terminal 3, the terminal 2 uses its video image sensor 7 during a process E10 to acquire a signal SIG comprising an audio stream and a video stream.

In accordance with one embodiment of the invention, the transmission device 8 incorporated in the terminal 2 then makes use in particular of its parameter-obtaining module 8B2 to analyze in real time the signal SIG as acquired in this way, and more specifically to analyze the video component (i.e. the video stream) of this signal.

Thus, the acquisition process E10 is followed by a process E20 of acquiring a parameter PQA representative of the quality with which the sensor 7 is acquiring the video images that are conveyed by the video stream of the signal SIG. In this example, acquisition quality represents the quality of the conditions under which the images conveyed by the video stream are acquired by the sensor 7, in other words the “cinematographic” or “photographic” quality of the images in the video stream.

In the presently-described implementation, the process E20 of obtaining the parameter PQA representing this cinematographic quality is made up of two subprocesses E21 and E22 that are performed by the parameter-obtaining module 8B2.

The subprocess E21 is a process of determining one or more quality indices for the images in the video stream of the signal SIG. In the presently-considered example, the transmission device 8 determines three quality indices, namely:

an index IND QUAL CENTR relating to the quality which the images in the video stream are framed;

an index IND QUAL STAB relating to the quality of the digital stability of the sensor 7 used for acquiring the images of the video stream; and

an index IND QUAL LUM relating to the quality with which the images of the video stream are lighted.

These indices are in the form of binary numbers, with a value “0” being representative of quality that is insufficient for the characteristic under consideration, and a value “1” being representative of that characteristic having quality that is sufficient.

Naturally, it is possible to select some other number of indices and/or other quality indices in order to determine the parameter PQA, for example there may be an index relating to the colorimetric quality of objects present in the video scene, possibly in combination with one or more of the above-mentioned indices.

Furthermore, these quality indices may have real values rather than binary values.

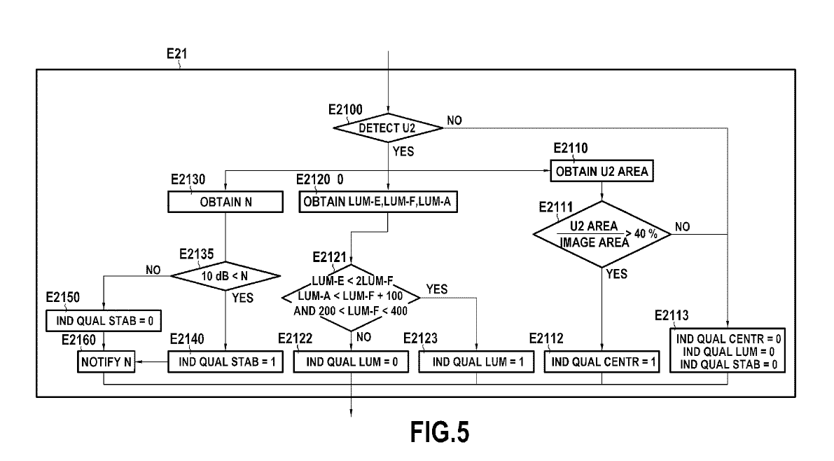

A detailed example of how process E21 can be implemented is shown in non-limiting manner in FIG. 5, which is described below.

After determining the quality indices IND QUAL LUM, IND QUAL STAB, and IND QUAL CENTR, the transmission device 8 then acts during the subprocess E22 to determine the parameter PQA representative of the acquisition quality of the images in the video stream on the basis of these quality indices, e.g. by applying predefined combinational logic to these indices.

In a variant, if the quality indices are real values, the transmission device 8 may determine the parameter PQA on the basis of a weighted combination of the quality indices evaluated in process E21.

Thus, in the presently-described implementation, the quality parameter PQA is obtained by performing a logic AND operation between the quality indices IND QUAL LUM, IND QUAL STAB, and IND QUAL CENTR. The parameter PQA is then equal to 1 if all of the quality indices taken into consideration are equal to 1, otherwise it is equal to 0.

Thereafter, the transmission device 8 acts during a process E30 to determine whether the quality parameter PQA as obtained in this way is or is not representative of quality that is sufficient (in other words representative of acquisition quality that is greater than a predetermined quality level).

For this purpose, it compares the binary value of the quality parameter PQA with the value “1”.

If the parameter PQA is equal to 1, the acquisition quality of the images in the video stream is considered as being satisfactory (response “yes” in process E30). Where appropriate, during a process E40, the transmission device 8 transmits the signal SIG in full to the terminal 3 via its transmit module 8B3. In other words, it transmits both the audio stream and the video stream of the signal SIG to the terminal 3.

If, on the contrary, the parameter PQA is equal to 0, the acquisition quality of the images in the video stream is considered as being insufficient (response “no” to process E30). Where appropriate, the transmission device 8 acts during a process E50 to transmit only a portion of the signal SIG to the terminal 3 via its transmit module 8B3, namely only the audio component of the signal (i.e. the audio stream). In other words, it transmits only the audio stream to the terminal 3 and it blocks the video stream with the help of its blocker module 8B4 so that the video component of the signal SIG is not transmitted to the terminal 3. During the video conference session, the user U3 of the terminal 3 can thus access only the sound recorded by the user U2 of the terminal 2 with the help of the webcam 7, and is not troubled by an image of insufficient quality.

In a variant, the transmission device 8 may transmit a predefined image together with the audio stream in the event of determining that the acquisition quality of the images conveyed by the video stream acquired by the terminal 2 is not sufficient (in other words when the transmission device determines that the parameter PQA does not represent acquisition quality greater than a predetermined quality level). The predefined image may be a uniform color image, e.g. black, or an image selected in advance by the user U2 (e.g. a photo of the user U2 or an avatar).

In the presently-described implementation, the transmission device 8 also acts during a process E55 to notify through its notification module 8B5 the terminal 2 an information representative of the acquisition quality of the video stream. By way of example, this information may be the parameter PQA as determined in the process E30.

In a variant, the transmit device 8 performs the process E55 of notifying the terminal 2 only if the parameter PQA is representative of an acquisition quality that is not greater than said predetermined quality level.

Naturally, other types of information may be transmitted to the terminal 2, such as for example all of the quality indices calculated in process E21, or a specific didactic message indicating which index(ices) is/are insufficient, or indeed corrective measures that need to be taken.

On receiving this information, the terminal 2 may, most advantageously, inform the user U2 about the acquisition quality of the video stream so that the user can consider taking corrective measures. By way of example, if the acquisition quality is poor, the terminal 2 may inform the user U2 about actions to be taken in order to remedy that.

Thus, in the event of poor framing (i.e. the index IND QUAL CENTR is equal to zero), the terminal 2 displays an informative message on its screen recommending simple actions that the user can easily perform to improve the quality of the framing.

For example, the terminal 2 may suggest to the user U2 that the viewing angle of the webcam should be modified so as to ensure the user's head is fully contained in the field of the images constituting the video stream, or indeed that the user should use the zoom or should come closer to the camera so that the user's face occupies a larger fraction of the images constituting the acquired video stream.

In another example, on detecting poor lighting quality (i.e. the index IND QUAL LUM is equal to zero), the terminal 2 searches for the presence of backlighting, e.g. by analyzing brightness in a plurality of zones of the image. When backlighting is detected, the terminal 2 displays on its screen a message of the type “A high level of backlighting has been detected, and your face is under-exposed, we suggest you close a curtain and/or switch on additional lighting to illuminate your face.” thus enabling the user of the terminal 2 to take appropriate action for improving the quality of lighting.

In yet another example, when poor quality is detected in the digital stability of the sensor 7 (i.e. the index IND QUAL STAB is equal to zero), the terminal 2 displays on its screen a message of the type “Your image is moving too much, take care to remain as still as possible.”

In the presently-described implementation, the process E20 of obtaining the parameter PQA representative of the acquisition quality of the images in the video stream, the process E30 of comparing the parameter with a predetermined quality level, the notification process E55, and as appropriate the processes E40 and E50 of transmitting the signal SIG in full or in part to the terminal 3, are performed periodically, so as to be able to detect in real time that the acquisition quality of the video images is insufficient and to provide an appropriate response in accordance with some embodiments of the invention.

In a variant, the processes may be performed at various predetermined instants.

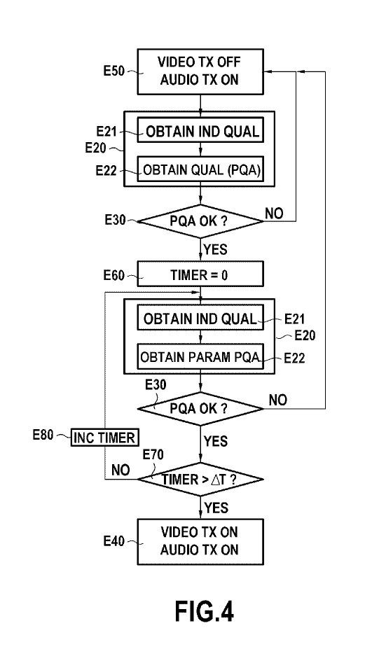

Such periodic performance of the processes E20 and E30 makes it possible in particular to reactivate transmission of the video stream via the transmit module 8B3 after it has been blocked in process E50, whenever the parameter PQA becomes or again becomes representative of image acquisition quality in the video stream that is satisfactory (i.e. greater than a predetermined quality level, specifically equal to the value “1” in the above-described example). In the presently-described implementation, this (re)activation of transmission of the video stream is accompanied by a hysteresis mechanism, as shown diagrammatically in FIG. 4, and described below.

Thus, process E50 of blocking the video stream is followed by a new process E20 of obtaining the parameter (PQA) representative of image acquisition quality in the video stream acquired at the current instant by the terminal 2, and a new process E30 of the transmission device 8 determining whether the parameter PQA is representative of a quality level that is satisfactory.

If the acquisition quality of the video images is insufficient (response “no” in process E30), the transmission device 8 continues to block the video stream while transmitting the audio stream (process E50).

Otherwise, a timer TIMER is initialized to zero during a process E60.

The processes E20, E30, and E80 are reiterated so long as the parameter PQA is representative of a satisfactory quality level and so long as the timer TIMER has not reached a predefined duration ΔT, which is tested during a process E70.

If in process E70 the transmission device 8 detects that the value of the timer TIMER is greater than the predefined duration ΔT, it activates full transmission of the signal SIG to the terminal 3 (i.e. both the audio component and the video component of the signal, as acquired by the terminal 2). Otherwise, the timer is incremented.

In another implementation, the processes E20-E50 may be performed once only, when starting the video conference session in which the users U2 and U3 of the terminals 2 and 3 are participating. In this implementation, the decision whether to transmit the signal SIG to the terminal 3 in full or in part only is consequently a final decision.

With reference to FIG. 5, there follows a description of a detailed implementation of process E21 that comprises determining the quality indices IND QUAL STAB, IND QUAL LUM, and IND QUAL CENTR. This example is given purely by way of illustration and is not itself limiting.

In the presently-described implementation, the indices IND QUAL STAB, IND QUAL LUM, and IND QUAL CENTR are evaluated on the basis of the video stream of the signal SIG by the transmission device 8.

It should be observed that some or all of the above-mentioned quality indices may be evaluated either by the sensor 7 or by the transmission device 8. When the quality indices are evaluated by the sensor 7, they may be transmitted to the transmission device 8 together with the video stream, e.g. in the form of metadata associated with the stream. Such methods of transmitting metadata are well known to the person skilled in the art and they are not described herein.

In the example shown in FIG. 5, the index IND QUAL CENTR concerning framing quality is evaluated in binary manner by acting during a process E2100 to detect the presence or the absence of a face in the sequence of animated images conveyed by the video stream. Algorithms for detecting faces (or other characteristic shapes) in a video are known to the person skilled in the art and are therefore not described in detail herein.

If no face is detected (response “no” in process E2100), the transmission device 8 gives the value “0” to the index IND QUAL CENTR during a process E2113, this value corresponding to framing quality that is not satisfactory. In this example, it also gives the value “0” to the index IND QUAL LUM concerning lighting quality.

In contrast, if one or more faces are detected (response “yes” in process E2100), the transmission device 8 then calculates the area occupied by the face(s) (e.g. as a number of pixels) during a process E2110.

The ratio of the area occupied by the face(s) over the total area of the image is then compared with a predetermined threshold, e.g. 40%, during a process E2111.

If this ratio is greater than the threshold (response “yes” in process E2111), the value “1” associated with satisfactory framing quality is given to the framing quality index IND QUAL CENTR during a process E2112.

Otherwise, the transmission device 8 gives the value “0” to this index during a process E2113. In this example, the value “0” is also given to the indices IND QUAL LUM and IND QUAL STAB during this process E2113.

The index IND QUAL STAB relating to the quality of the stability of the sensor 7 is evaluated by the transmission device 8 on the basis of the signal SIG. More precisely, it is assumed herein that the transmission device 8 has a digital stabilizer device: in known manner, digital stabilization consists in increasing the sensitivity of the sensor in order to have a shorter exposure time when movement of the sensor is detected. Such a method is accompanied by the appearance of digital noise that is quantifiable in a manner known to the person skilled in the art.

In the example shown in FIG. 5, when a face is detected (response “yes” in process E2100), the transmission device 8 evaluates the movements of the face by comparing successive images of the video stream of the signal SIG and thereafter it determines a digital noise level N (process E2130).

Thereafter, during a process E2135, the transmission device 8 verifies whether the digital noise level N is greater than a predetermined level, e.g. 10 decibels (dB). If so, the transmission device 8 considers that the stability quality of the sensor 7 is acceptable, so it gives the value “1” to the index IND QUAL STAB (process E2140).

Otherwise, the value “0” representative of insufficient stability quality is given to the index IND QUAL STAB relating to the quality of the digital stability of the sensor 7 (process E2150).

In the presently-described implementation, the transmission device 8 also acts during a process E2160 to notify the terminal 2 of the previously evaluated digital noise level N. On receiving this notification, the terminal 2 may act on the sensitivity of the sensor 7, if necessary, in order to take the digital noise level N above the predetermined level. In other words, the transmission device 8 uses a closed loop to regulate the digital stability of the sensor 7 so as to constrain the level of the digital noise generated by the sensor 7 to be greater than a predetermined level.

As mentioned above, the transmission device 8 also acts during the process E21 to determine the index IND QUAL LUM concerning lighting quality. In this example, this index is determined by performing multizone analysis of the brightness of the images in the video stream of the signal SIG.

Such analysis methods are known to the person skilled in the art: they are used in particular in numerous commercially-available digital camera devices.

In the presently-described example, it is assumed that the transmission device 8 uses such an analysis method during the process E2120 to determine three brightness parameters LUM-F, LUM-E, and LUM-A characterizing the brightness of the image in three zones, namely:

the brightness of the face detected during process E2100;

the brightness at shoulder level; and

the brightness of the remainder of the image (ambient brightness).

In this example, the shoulder zone where the brightness parameter LUM-E is evaluated is defined in relative manner from the previously-identified face zone.

The previously-identified face zone is taken to be an ellipse. The two main axes of the ellipse define a Cartesian reference frame. The axes of this Cartesian reference frame are oriented respectively upwards and to the right in the images constituting the video stream. The points of intersection between the two axes of the ellipse and the ellipse itself define four points respectively having the following coordinates (−X,0), (X,0), (0,−Y), and (0,Y).

In the reference frame as defined in this way, the shoulder zone is defined by two rectangles R1 and R2. R1 is defined by the vertices (+X, −Y), (+X, −Y*1.1); (+X*1.25, −Y), and (+X*1.25, −Y*1.1), and R2 is defined by the vertices (−X, −Y), (−X, −Y*1.1), (−X*1.25, −Y), and (−X*1.25, −Y*1.1). Thereafter, during a process E2121, the transmission device 8 verifies the following three conditions in order to give a value to the lighting quality index IND QUAL LUM, e.g. in this example:

1) if face brightness LUM-F has a value lying in the range 200 lux (lx) to 400 lx;

2) if shoulder level brightness LUM-E does not exceed twice the value of face brightness LUM-F; and

3) if ambient brightness LUM-A does not differ from face brightness LUM-F by more than 100 lx.

If these three conditions are satisfied (response “yes” in process E2121), then the transmission device 8 gives a value “1” to the lighting quality index IND QUAL LUM during a process E2123. This value “1” represents satisfactory lighting quality.

Otherwise, (response “no” in process E2121), the lighting quality index IND QUAL LUM is given a value “0” during a process E2122, representing insufficient lighting quality.

It should be observed that the numerical values given in processes E2111, E2121, and E2135 are given by way of indication and are not themselves limiting.

In a variant, it is possible to use other methods for evaluating a framing quality index, a sensor stability quality index, and/or a lighting quality index (with this applying to the methods of analysis giving rise to the indices and to the thresholds that are applied for determining the values “0” or “1”).

In the above-described first embodiment, the transmission device 8 is incorporated in the terminal 2. In a second embodiment, the transmission device is no longer incorporated in the terminal, but rather in a video conference server of a video conference system 1′ of one embodiment of the invention.

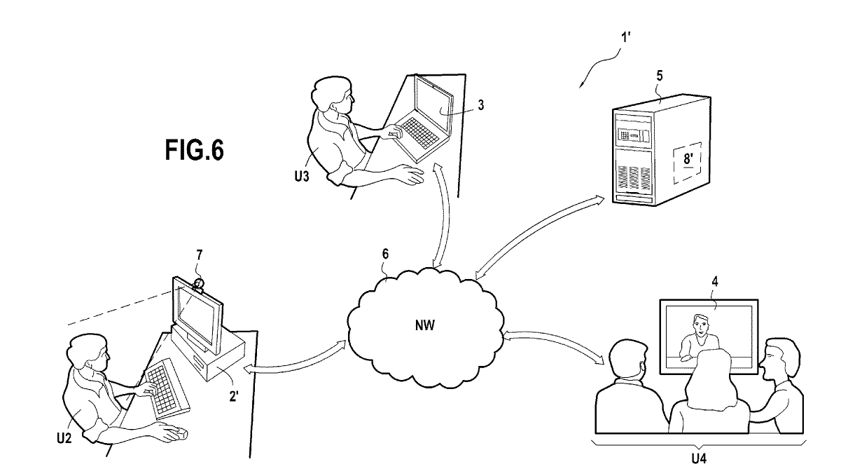

FIG. 6 shows this second embodiment. For simplification purposes, identical references are used in this figure for the elements it has in common with the first embodiment, as shown in FIG. 1.

The video conference system 1′ comprises:

a plurality of terminals 2′, 3, 4 participating in a video conference, and communicating with one another via a telecommunications network 6; and

a transmission device 8′ in accordance with one embodiment of the invention.

The terminal 2′ is a terminal in accordance with one embodiment of the invention such as a desktop computer having a video image sensor 7 (specifically a webcam) enabling the user U2 to participate in a video conference with the user U3 of the terminal 3 and the users U4 of the terminal 4. In this example the terminal 3 is a laptop computer and the terminal 4 comprises dedicated video conference equipment installed in a video conference room in which lighting and framing conditions are under control.

In this second embodiment, the video conference service between the users U2, U3, and U4 is governed by a video conference server 5 connected to the telecommunications network 6 and including the transmission device 8′. Thus, the transmission device 8′ differs from the transmission device 8 shown in FIG. 1 in that it is to be found in this embodiment in the video conference server 5 rather than in the terminal 2′.

Thus, in this second embodiment of the invention, the signal SIG acquired by the terminal 2′ is transmitted to the video conference server 5, and more particularly to the transmission device 8′ in this server. The transmission device 8′ proceeds as described above with reference to FIGS. 1 to 5 to process the signal SIG and block transmission of the video stream of the signal (i.e. block the images only of the signal) to the terminals 3 and 4 when the quality of video image acquisition by the webcam 7 is insufficient.

What is claimed is:

1. A method of transmitting at least a portion of a signal acquired by a first terminal to at least one second terminal during a video conference session, said signal comprising an audio stream and a video stream conveying video images acquired with the help of at least one video image sensor associated with the first terminal, said transmission method comprising:
a parameter-obtaining process for obtaining a parameter representative of a quality of the acquisition performed by the sensor of the video images conveyed by the video stream of the signal;
a notifying process for notifying the first terminal of at least one item of information representative of the acquisition quality of the video images conveyed by the video stream, said representative information enabling a user of said first terminal to take corrective action seeking to improve the acquisition quality of the video images by said sensor; and
if this parameter is representative of an acquisition quality that is higher than a predetermined quality level, a process of transmitting both the audio stream and the video stream of the signal to said at least one second terminal;
or else:
a process of transmitting the audio stream to said at least one second terminal; and
a process of blocking the video stream so that the video stream is not transmitted to said at least one second terminal.

2. A method according to claim 1, wherein said notifying process is performed only if said parameter is representative of an acquisition quality that is not greater than said predetermined quality level.

3. A method according to claim 1, further including, if the parameter does not represent acquisition quality greater than a predetermined quality level, a process of transmitting a predetermined image to said at least one second terminal.

4. A method according to claim 1, wherein the process of obtaining the parameter is performed periodically.

5. A method according to claim 1, wherein the process of obtaining the parameter is performed when starting the video conference session.

6. A method according to claim 1, comprising, following a process of blocking the video stream, a process of activating transmission of the video stream together with the audio stream if the acquisition quality is greater than the predetermined quality level for at least a predefined duration.

7. A method according to claim 1, wherein the parameter takes account of at least one quality from among:
a framing quality of the video images conveyed by the video stream and acquired by the video image sensor;
a stability quality of the video image sensor during acquisition of the video images conveyed by the video stream; and
a lighting quality during the acquisition of the video images conveyed by the video stream.

8. A computer program including instructions for executing the transmission method according to claim 1 when said program is executed by computer.

9. A non-transitory computer readable storage medium having recorded thereon a computer program including instructions for executing the transmission method according to claim 1.

10. A transmission device for transmitting at least a portion of a signal acquired by a first terminal to at least one second terminal during a video conference session, the signal comprising an audio stream and a video stream conveying video images acquired with the help of at least one video image sensor associated with the first terminal, the transmission device comprising:
a module for obtaining a parameter representative of a quality of the acquisition performed by the sensor of the video images conveyed by the video stream of the signal;
a module for notifying the first terminal of at least one item of information representative of the acquisition quality of the video images conveyed by the video stream, said representative information enabling a user of said first terminal to take corrective action seeking to improve the acquisition quality of the video images by said sensor;
a module for transmitting both the audio stream and the video stream of the signal to said at least one second terminal, which module is activated if the parameter is representative of an acquisition quality greater than a predetermined quality level; and
said device being suitable for activating, when said parameter is representative of an acquisition quality that is not greater than said predetermined quality level:
a module for transmitting the audio stream to said at least one second terminal; and
and a module for blocking the video stream so that the video stream is not transmitted to said at least one second terminal.

11. A terminal including a transmission device according to claim 10.

12. A video conference server including a transmission device according to claim 10.

13. A video conference system comprising:
a first terminal and at least one second terminal; and
a transmission device according to claim 10, suitable for transmitting at least a portion of a signal acquired by the first terminal to said at least one second terminal during a video conference session, the signal comprising an audio stream and a video stream conveying video images acquired with the help of at least one video image sensor associated with the first terminal.
